(19) United States
(12) Patent Application Publication
(10) Pub. No.: US 2006/0074513 A1
(43) Pub. Date: Apr. 6, 2006

(54) System and method for monitoring tool usage

(76) Inventors: Lynn Ann DeRose, Gloversville, NY (US); Patricia Denise Mackenzie, Clifton Park, NY (US); Douglas Roy Forman, Niskayuna, NY (US)

Correspondence Address: Patrick S. Yoder;FLETCHER YODER, P.O. Box 692289, Houston, TX, 77269-2289, US

(21) Appl. No.: 10/951,403

(22) Filed: Sep. 28, 2004

(51) Int. Cl. G06F 19/00

(52) U.S. Cl. 700/175; 702/184

(57) ABSTRACT

A tool usage monitoring system and method is provided. The system comprises a sensing element for detecting when a tool is in use and producing a signal representative of tool usage. A processor-based device that is communicatively coupled to the sensing element is also provided. The processor-based device is programmed to maintain a running total of tool usage based on the signal representative of tool usage. The processor-based device also is operable to store a defined tool usage total corresponding to the tool. The system further comprises a user interface coupled to the processor-based device. The processor-based device is programmed to send a signal to the user interface when the running total of tool usage either equals or exceeds the defined tool usage total. The system is also capable of monitoring usage of a plurality of tools.

### BACKGROUND

The invention relates generally to tool usage monitoring systems, and more particularly to a system and method for monitoring tool usage for calibration verification or replacement purposes.

A measuring device typically is calibrated to ensure that the device will provide an accurate measurement when it is used to take a measurement. Calibration is a process to standardize a measuring device by determining the amount of deviation between a measurement taken by the measuring device and a standard. The deviation of the measurement from the standard is then used to apply a correction factor to the measuring device so that the measuring device produces an accurate measurement. It may be desirable to periodically check the calibration of the measuring device and/or re-calibrate the measuring device. For example, wear and tear on the measuring device caused by the use of the measuring device may cause the device over time to begin providing erroneous measurements. Periodically checking the calibration or re-calibrating the measuring device enables a user to have confidence that the measurements taken with the measuring device are accurate. In addition, certain measuring devices and tools may have a limited lifetime and must be replaced once the lifetime of the measuring device or tool is complete.

Prior attempts to maintain the calibration of measuring devices have focused mainly on scheduling the measuring devices for a check of the calibration or a recalibration after a specified period of time has elapsed from a previous calibration check or calibration. However, this is not an efficient scheme for maintaining a measuring device calibrated as the tool may sit unused for significant periods of time. Therefore, the measuring device is not experiencing the type of usage that would tend to cause the device to begin providing erroneous measurements. Alternatively, the measuring device may be used to a greater extent than expected. Thus, the device may become un-calibrated due to excessive usage. Similarly, a calibration check of the measuring devices may be scheduled based on the number of days that the device is used, regardless of the amount of usage on a given day. However, this method is also inefficient, as it also does not accurately reflect actual wear and tear on the device. Alternatively, the relevant usage data, such as the number of actual uses, may be collected. However, this is usually done manually. For example, the use of the device may be logged by hand in a logbook. However, these types of manual data collection methods are usually inefficient and can lead to errors in data collection and analysis. As a result, a tool may be checked for calibration too infrequently and thereby become un-calibrated before its scheduled calibration check. Alternatively, the tool may be checked for calibration too frequently, thereby adding unnecessary expense and loss of productivity.

In addition, attempts have been made to schedule preventative maintenance or even tool replacement using similarly inefficient methods. For example, a tool may be scheduled for replacement after a predetermined calendar life or after a predetermined number of days in use.

Furthermore, such attempts have been in a manner that either obstructs or interferes with the normal course of production. For example, one method of monitoring daily usage of a measuring device is to require the device to be checked out from a tool crib each day or at the beginning of a shift. Thus, the tool must be returned to the tool crib at the end of the day or at the end of the shift. With large devices, this may mean locking the device when not in use and requiring a user to check out the key to the lock from the tool crib to enable the user to operate the device. Consequently, these methods reduce the efficiency of production.

Therefore, there is a need for an efficient system or method for ensuring that measuring devices or tools are maintained in condition to provide accurate measurements. In addition, there is a need for a system or method for maintaining the device calibrated that minimizes interference with the operation of the device or inconvenience to the user of the measuring device or tool.

### BRIEF DESCRIPTION

According to one aspect of the present technique, a tool usage monitoring system and method is provided. The system comprises a sensing element for detecting when a tool is in use and producing a signal representative of tool usage. A processor-based device that is communicatively coupled to the sensing element is also provided. The processor-based device is programmed to maintain a running total of tool usage based on the signal representative of tool usage. The processor-based device also is operable to store a defined tool usage total corresponding to the tool. The system further comprises a user interface coupled to the processor-based device. The processor-based device is programmed to send a signal to the user interface when the running total of tool usage either equals or exceeds the defined tool usage total. The system is also capable of monitoring usage of a plurality of tools.

In accordance with another aspect of the present technique, a computer program is provided. The program comprises programming instructions that direct a processor to receive usage data of the calibrated device and produce a signal to indicate to a user to check calibration of the calibrated device when a running total of usage of the calibrated device achieves a predefined amount of usage.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of a centralized tool usage monitoring system, in accordance with an exemplary embodiment of the present technique;

FIG. 2 is a detailed diagrammatic representation of the tool usage monitoring system illustrated in FIG. 1;

FIG. 3 is a flow chart illustrating an exemplary method for tool usage monitoring using the system of FIG. 1, in accordance with an exemplary embodiment of the present technique;

FIG. 4 is a perspective view of a tool usage monitoring system, illustrating a work piece mounted on a calibration device, such as a tool or gage, having a light source and receiver arrangement for detecting placement of the work piece on the tool, in accordance with an exemplary embodiment of the present technique;

FIG. 5 is a perspective view of the tool usage monitoring system shown in FIG. 4, illustrating detection of the work piece on the calibration device, such as a tool or gage, by the light source and receiver arrangement;

FIG. 6 is a cross-sectional view of a mount for receiving the light source, in accordance with an exemplary embodiment of the present technique;

FIG. 7 is a perspective view of a tool usage monitoring system having a proximity sensor for sensing a work piece disposed on a calibration device, such as a tool or gage, in accordance with an alternate embodiment of the present technique;

FIG. 8 is a perspective view of a tool usage monitoring system having a conductivity switch for sensing a conductive path established by a work piece being disposed on a calibration device, such as a tool or gage, in accordance with a second alternative embodiment of the present technique;

FIG. 9 is the top view of the calibration device of FIG. 8, illustrating the conductive path established by the work piece with the calibration device, such as a tool or gage;

FIG. 10 is an diagrammatic view of a tool monitoring system having a multi-meter and a transmitter for transmitting use of the multi-meter to the central monitoring system, in accordance with a third alternative embodiment of the present technique;

FIG. 11 is an elevation view of a tool monitoring system having an acoustic sensor to detect gear movement, in accordance with an fourth alternative embodiment of the present technique; and

FIG. 12 is an elevation view of a tool monitoring system having a magnetic sensor to detect gear movement, in accordance with a fifth alternative embodiment of the present technique.

### DETAILED DESCRIPTION

In the subsequent paragraphs, various aspects of a technique for automatically monitoring the usage of a tool in a workplace will be explained. The various aspects of the present techniques will be explained, by way of example only, with the aid of figures hereinafter.

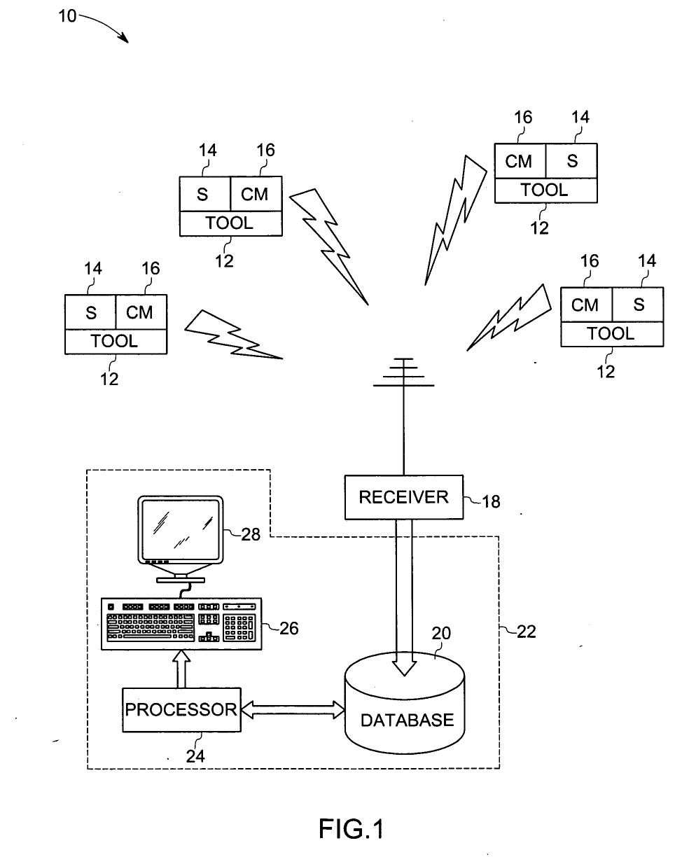

Referring generally to FIG. 1, an illustration of a centralized tool usage monitoring system 10 is shown. The tool usage monitoring system 10 may be used to monitor usage of tools, calibrated devices, such as gages and meters, and the operation of various devices. In FIG. 1, a plurality of tools 12 is located at various locations in a production facility. Each of the tools 12 is coupled with a hardware interface or sensor 14 that is operable to detect when the tool 12 is in use. Each of the tools 12 has a unique identifier. The unique identifier may be a unique number that is used to distinguish each tool and its corresponding hardware interface 14. The unique identifier facilitates tracking and monitoring of each individual tool.

In the illustrated embodiment, a communications module 16 is coupled to each tool 12 to transmit tool usage data corresponding to the use of the tool 12 to a receiver module 18. The communications module 16 may also transmit the unique identifier associated with the tool 12 to the receiver module 18. As illustrated, the communications module 16 and receiver module 18 are in wireless communication. However, wired communication between the communications module 16 and the receiver 18 may also be used. The tool use data is received by the receiver 18 and stored in a database 20 located in a central monitoring station 22. In addition, a processor-based device 24 is coupled to the database 20 to utilize the data stored in the database for analysis and decisioning. If the usage data for a tool 12 indicates that the tool 12 has been in operation for a defined period of time, or for a defined number of uses, or a combination of both the number of uses and the duration of use corresponding to a maintenance activity, the processor-based device 24 produces a signal to inform a maintenance person to perform a maintenance check for the tool 12. Recalibration or replacement may then be effected accordingly.

The central monitoring station 22 also comprises a keyboard 26 for entering data into the processor-based device 24, such as the defined amount of usage that a particular tool 12 may be in use before a calibration check or replacement should be performed, and the results of maintenance performed on the tool. The defined amount of usage may be changed depending on the result of the maintenance activity performed on the tool or device. For example, it may be established that the tool does not need to be calibrated as often as it is currently scheduled. Consequently, the defined amount of tool usage may be increased. Conversely, it may be discovered that the tool should be checked more often than the currently defined usage. A user may enter data corresponding to each tool 12 located in the workshop, factory, or manufacturing plant via the keyboard 26. Alternatively, the user may enter data corresponding to each category of tools. A display monitor 28 is also present in the central monitoring station 22 for displaying information. Alternatively, the analysis of the data may be available globally via the Internet or other networked systems. Such an analysis may include, but may not limited to, the total of tool usage, the number of times the tool was used, the duration of use, etc. The analysis may also include a notification that a tool has achieved a defined amount of usage corresponding to a maintenance activity to be performed on the tool 12, the results of any maintenance performed on the tool, current tool use statistics, the tool inventory, and the like, for all of the tools 12 coupled to the central monitoring station 22. Using the keyboard 26, the monitor 28, and the Internet, a user may check the current usage statistics of any tool 12 coupled to the central monitoring station 22.

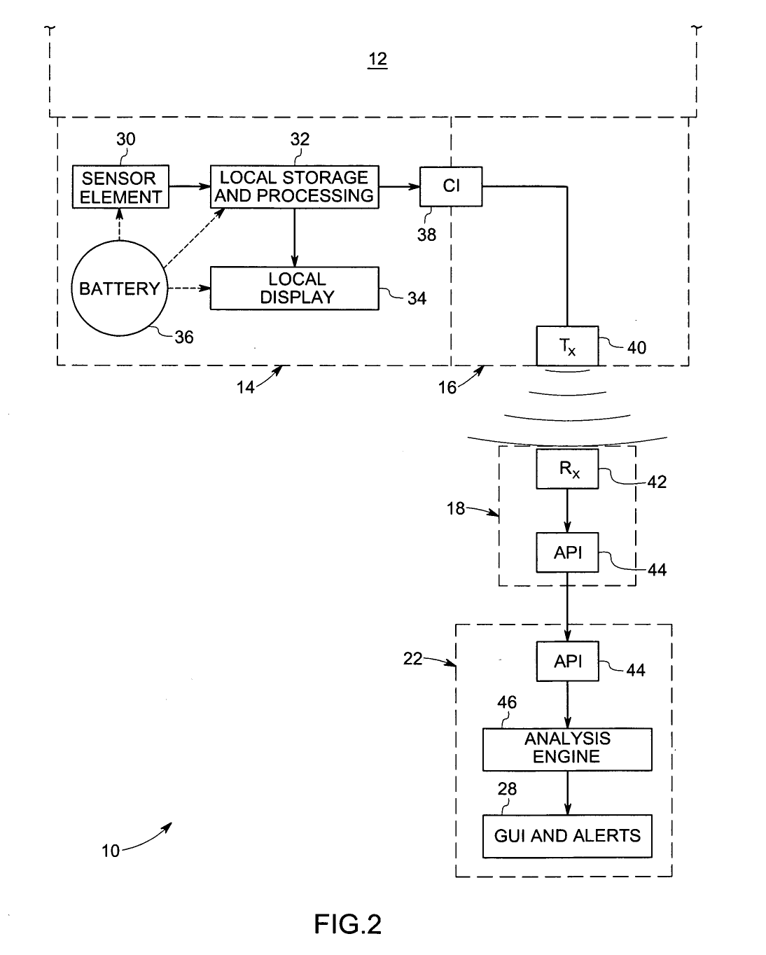

Referring generally to FIG. 2, a detailed diagrammatic view of the tool usage monitoring system 10 is illustrated. The tool usage monitoring system 10 is operable to track actual usage of a tool automatically without any input from a tool user. In addition, the tool usage monitoring system 10 is operable to track the tool usage and to schedule periodic maintenance of the tool, such as a calibration check, based on the actual duration of use, the number of times the tool was used, or a combination of factors that represent use of the tool 12. However, the actual tool usage data may be used for other purposes, as well.

The illustrated embodiment of the tool usage monitoring system 10 comprises the hardware interface 14, the communications module 16, the receiver module 18, and the central monitoring station 22. As noted above, the hardware interface 14 is operable to establish whether the tool 12 is in use or not. The actual usage data is coupled to the communications module 16 for transmission to the receiver module 18. The receiver module 18 couples the actual usage data to the central monitoring station 22. The processor 24 (shown in FIG. 1) is operable to track the actual usage of the tool and to establish when a desired action on the tool 12 is to be performed, such as checking the calibration of the tool or replacing the tool 12, based on the amount of time that the tool 12 is actually in use, the number of times that the tool was used, or the number of days that the tool was used. In this embodiment, the hardware interface 14 and the communications module 16 are disposed locally and correspond to a single tool, while the data interface 18 and the central monitoring station 22 are disposed remotely. In addition, the communications module 16 and the data interface 18 are operable to transmit data wirelessly, including the actual tool usage data. These components will be explained in further detail in the following description.

The hardware interface or sensor 14 comprises a sensing element 30 that is operable to detect when the tool 12 is in use. The sensing element 30 is coupled to the tool 12 and an optional local storage and processing device 32 in this embodiment. The sensing element 30 is adapted to provide a signal to enable the system to identify periods of actual usage of the tool 12. The tool usage data may be used to inform a user when a desired activity should be performed, such as periodic maintenance on the tool or even replacement of the tool. Depending on the application of the tool, various embodiments of the sensing element 30 may be used. For example, if the tool is a gage, the sensing element 30 may be a proximity sensor operable to provide an indication when an object to be measured is disposed on the gage. The following are examples of various types of sensors that may be used for detecting when a tool is in use or when the tool is not in use: a low voltage conductivity switch, a magnetic sensor, a laser sensor, an LED sensor, an infrared laser sensor, an infrared LED sensor, a rotating speed sensor, a spin sensor, a position sensor, a level sensor, a magnetic switch, a contact switch, an impact sensor, an acceleration switch, a direction sensor, a vibration sensor, a pressure sensor, a motion sensor, an acoustic sensor, a door or window sensor, or any of a variety of other sensor types. In addition, if the tool is electrically powered, such as a multi-meter, the sensor 14 may be coupled to an operating switch to indicate when the device is turned on and when the device is turned off.

The tool usage data generated by the sensing element 30 may be transmitted to the central monitoring station 22 for analysis and storage or it may be stored in the local storage and processing device 32 for preliminary processing. In this embodiment, the local storage and processing device 32 converts the various forms of sensed data into a format for easier communication. Also, the sensor data may be converted into data that can be used and processed locally. For example, in this embodiment, the local storage and processing device 32 processes the data from the sensing element 30 so as to provide an optional local display 34 with an indication of the duration of time that the tool has actually been in use overall or since a previous procedure was performed on the tool, etc.

The local display unit 34 may be utilized to display current statistical data of the state of the tools, and may also be utilized for displaying alerts when the tool requires a calibration check, replacement, or some other maintenance activity. A signal to inform a user that a calibration check, periodic maintenance, or some other activity, such as replacement of the tool is desired based on the amount of tool usage, may be provided from the processor 24 to the local display unit 34 when the amount of actual usage of the tool reaches a desired amount. Alternatively, the signal may be provided from the local storage and processing device 32 to the local display unit 34 or the signal may be processed at the central monitoring station 22 to be sent to relevant parties via e-mail, pager, cellular etc. The sensing element 30, the local storage and processing device 32, and the local display 34 are powered by a battery 36 in the illustrated embodiment. However, these components may also be coupled to a line source, as will be appreciated by one skilled in the art. As previously described, hardware interface 14 may further comprise a unique identification tag that identifies the tool, and the corresponding sensing element 30. In one embodiment, the identification tag helps in monitoring and collection of data and statistics of each tool of a plurality of tools monitored in a centralized manner.

The processed data is transferred from the tool to the data interface 18 and the processor 24 located in a central location through the communications module 16. The communications module 16 may be designed for wireless transmission of the processed sensor data. The communications module 16 comprises a communication interface 38 and a transmitter 40, such as a radio frequency (RF) transmitter that is operable to transmit RF data. However, other types of wireless communication may be used. In addition, a transceiver, rather than a transmitter, may be used when data is to be communicated from the receiver module 18 to the communications module 16. The transmitter 40 may be powered by a battery or alternatively be coupled to a line source.

The receiver module 18 has a receiver 42 that is operable to receive the data that is transmitted by the transmitter 40 of the communications module 16. The receiver 42 receives the sensor data and transfers the data to an application programming interface (API) 44. The function of the API 44 is to translate the sensor data that is received from the receiver 42 into a form that may be communicated to a corresponding API in the central monitoring station 22. An analysis engine 46 comprising the processor 24 and a program stored in the central monitoring station 22 enables a user to process the sensor data. The analysis engine 46 analyses the sensor data to establish whether the tool requires a calibration check, periodic maintenance, replacement, or some other activity based on the actual tool usage and set points stored in the central monitoring station 22 among other valuable information. The data generated by the analysis may be accessed globally via the Internet.

If the analysis engine 46 establishes that a desired activity should be performed, a signal is provided to the display unit 28 to display a request and/or an alert to inform the user that a desired action to the tool is to be performed. The display unit 28 may be configured to display the status of any tool that is linked to the system. Thus, the display unit 28 may function as the external user interface or output device. Alternatively, the status may be available via the Internet and notification to interested parties may be provided via e-mail, text message, etc. when an action is required. As previously described, the system may further comprise an input device such as a keyboard 26 for configuring the system for the various tools in the tool monitoring system 10.

It may be noted that one or more of the components of the tool monitoring system may be in a wireless or wired configuration. Also, computer readable instructions may be utilized to achieve the results, and in such a case, the computer readable instructions may be embedded in the processor 24, which may be a dedicated processor, such as an application specific integrated circuit (ASIC), or the instructions may be embedded in a micro-controller.

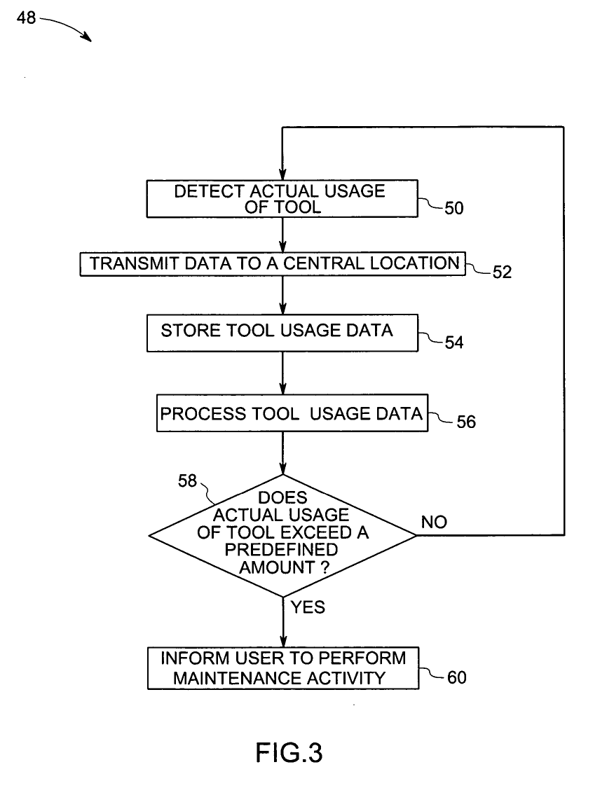

Referring generally to FIG. 3, a flow chart illustrating an exemplary method for operating the tool monitoring system to monitor the usage of a single tool or gage is illustrated generally by reference numeral 48. In the illustrated process, usage of a tool is detected, as represented generally by block 50. As noted above, the sensing element 30 illustrated in FIG. 2 may be used to detect the tool usage data. The tool usage data may be stored locally for preprocessing in the local storage and processing device 32 of FIG. 2 or sent to the central monitoring station 22 for analysis. The local display unit 34, illustrated in FIG. 2, may display the usage data stored in the local storage and processing device 32 or it may be available globally via the Internet.

The sensor data stored in the local storage and processing device 32, shown in FIG. 2, may be processed to generate alerts if re-calibration or replacement of the tool 12 is required. It may be noted that the local display unit 34, shown in FIG. 2, may be utilized to display the alerts in addition to the usage statistics or the information can be provided globally from the central monitoring station 22 via the Internet. In one embodiment, displaying of usage statistics or alerts in the local display unit 34 may be optional. For example, in cases where proper functioning of the tool is crucial for the working of the machine, a local display unit or a local alerting mechanism may be advantageous. In various embodiments of the present technique, the alerting mechanism may be a notification such as, a visual alert, an audible alert, a text message, or an electronic text message such as a paged message or an e-mail message.

The sensor data may optionally be preprocessed before transmission to the central monitoring station 22 illustrated in FIG. 1, as represented by block 52. Transmission of sensor data may be implemented by any of a radio frequency connection, a Bluetooth connection, a wireless infrared connection, or a wireless FM connection. However, as described previously, a wired connection may also be implemented to transmit the sensor data. The transmitted sensor data is stored in the database 20, shown in FIG. 1, as represented by block 54. The processor 24, shown in FIG. 1, processes the sensor data stored in the database 20, as represented by block 56. The processor 24 checks the processed sensor data to verify whether the tool or calibrated device 12 has been in operation for a predefined amount of time, or a predefined number of times that the tool was used, as represented by block 58. If the sensor data indicates that the tool or calibrated device is nearing the predefined time or number of uses corresponding to a periodic maintenance activity, such as a calibration check, or replacement of the tool, a corresponding alert or message may be displayed or issued, as represented by block 60. Therefore, maintenance personnel may perform the desired maintenance activity for the concerned tool or calibrated device. However, if the sensor data indicates that the tool has not been used for the predefined amount of time, or the predefined number of uses, the monitoring system continues to check the tool usage data in the database, as described hereinabove. In one embodiment, the predefined amount of time, or the predefined number of uses, that may be used to initiate the alert, may be configured to be lesser than the actual amount of time, or the actual number of uses, that the tool remains in a reliable operating condition. Similarly, the system is utilized for a plurality of tools, gages, and calibrated devices within a factory environment or workplace.

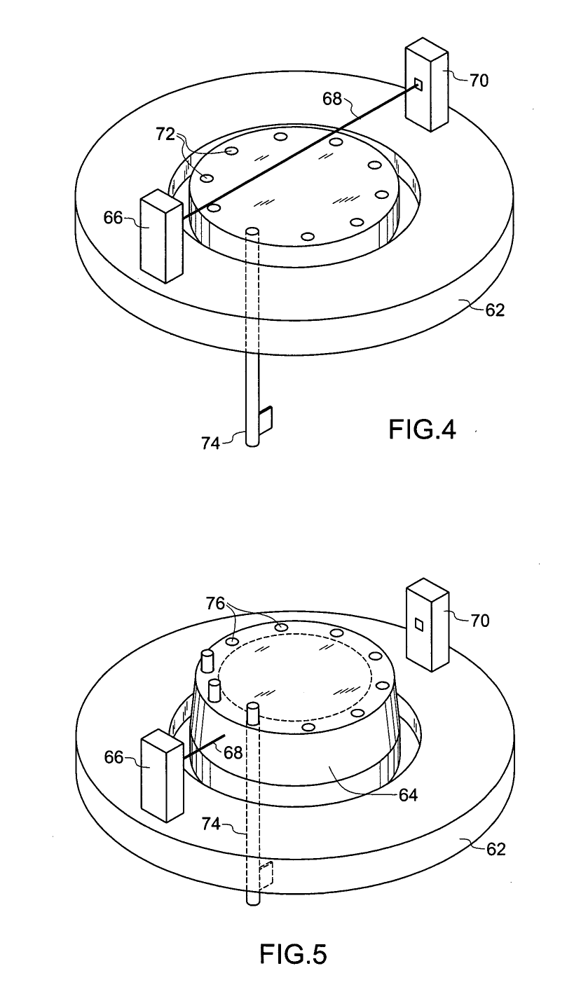

Referring to FIG. 4 and FIG. 5, a perspective view of an exemplary embodiment of a calibration gage is illustrated, and represented generally by reference numeral 62. The gage 62 is configured to enable a user to verify that a work piece 64 has been manufactured in accordance with a defined specification, such as correct dimensions, alignment of the work piece 64, etc. In the illustrated embodiment, to establish if the gage 62 is in use, the sensing arrangement is a light source 66 operable to transmit a light beam 68 to a receiver 70. The light source 66 may be a laser transmitter, an LED, a photo-diode, a phototransistor, etc., while the receiver 70 may be a photo-detector. As illustrated in FIG. 4, the receiver 70 receives the light beam 68 when the work piece is not disposed on the gage. FIG. 4 further illustrates a plurality of holes 72 through which a rod 74 can pass. A plurality of such rods 74 may be utilized to ascertain the alignment of the holes 76 (shown in FIG. 5) within the work piece 64.

As illustrated in FIG. 5, when the work piece 64 is mounted on the gage 62, the work piece 64 obstructs the light beam 68 and prevents the light beam 68 from reaching the receiver 70. In this embodiment, when the receiver 70 does not receive the light beam 68, the receiver 70 transmits a signal indicating that the gage 62 is in use. The receiver will continue to transmit a signal as long as the work piece 64 is disposed on the gage 62. However, the converse method of operation may also be used. In addition, the system may have a delay so that if a work piece 64 is placed on the gage 62 only briefly, then the system 10 will not considered the placement of the work piece 64 on the gage 62 as the beginning of operation of the gage 62. Similarly, in alternative embodiments, the gage 62 may comprise a weight sensing mechanism that verifies the weight of the work piece 64 before beginning to establish the duration of use. This technique enables the system to distinguish the work piece 64 from an object accidentally placed on the gage 62 that blocks the light beam 68.

A different type of transmitter and receiver arrangement may be used, such as a combination of a photo-diode and phototransistor. In a different embodiment, a combination of a photo transceiver and a photo-reflective material may be used. For example, a laser transceiver may be disposed on one side of the gage 62 and a reflective material or a mirror may be disposed on the opposite side of the worktable to achieve the same results.

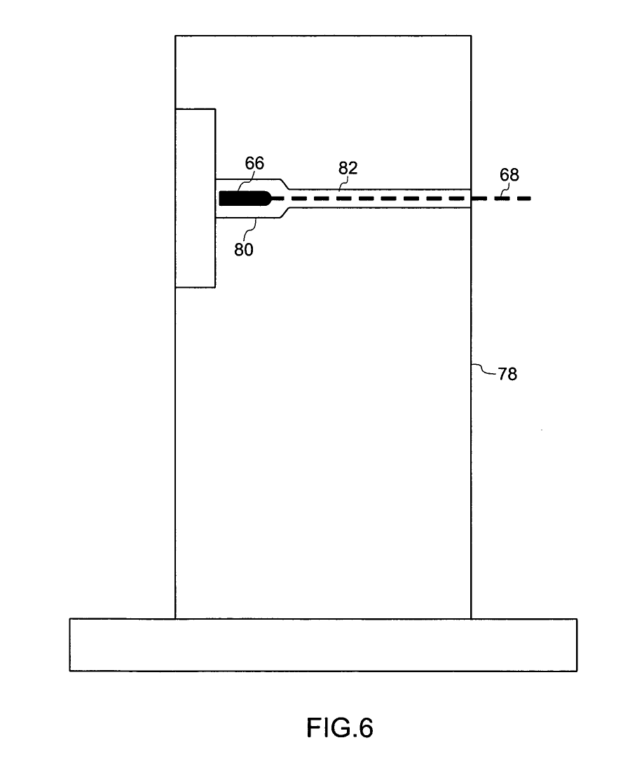

Referring generally to FIG. 6, a cross-sectional view of a sensor mount 78 is illustrated. The sensor mount 78 has a recess 80 for holding the light source 66. A narrower channel 82 is provided for focusing the light beam 68. The channel 82 is narrower to align the light beam 68 accurately with the receiver.

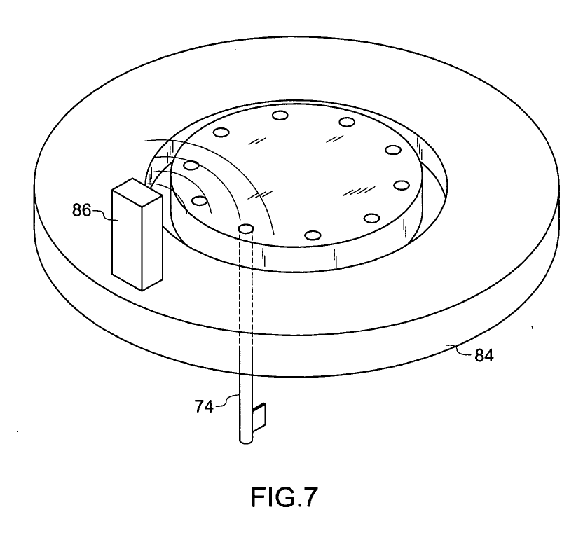

Referring generally to FIG. 7, a perspective view of an alternative embodiment of a gage 84 is illustrated. The gage 84 has a proximity sensor 86 for sensing when the work piece 64 (shown in FIG. 5) is mounted on the gage 84.

Referring generally to FIG. 8, a perspective view of a tool or gage 88 having a conductivity switch for sensing a conductive path established by a work piece 64 (shown in FIG. 5) disposed on the tool 88 is illustrated. The system uses two contact patch areas of metal 90 and 92 that form the conductivity switch, which initiates a timer. A very low voltage signal is passed to one contact area and when a metal part, such as the work piece 64, is placed on the gage 88 so that both contact areas are electrically coupled, the timer is initiated. Contact areas can be hidden within or to the side of the gage 88 using metal leads to make contact. The timer information can then be transmitted to a remote location, such as the central monitoring station 22, via one of the mechanisms described hereinabove.

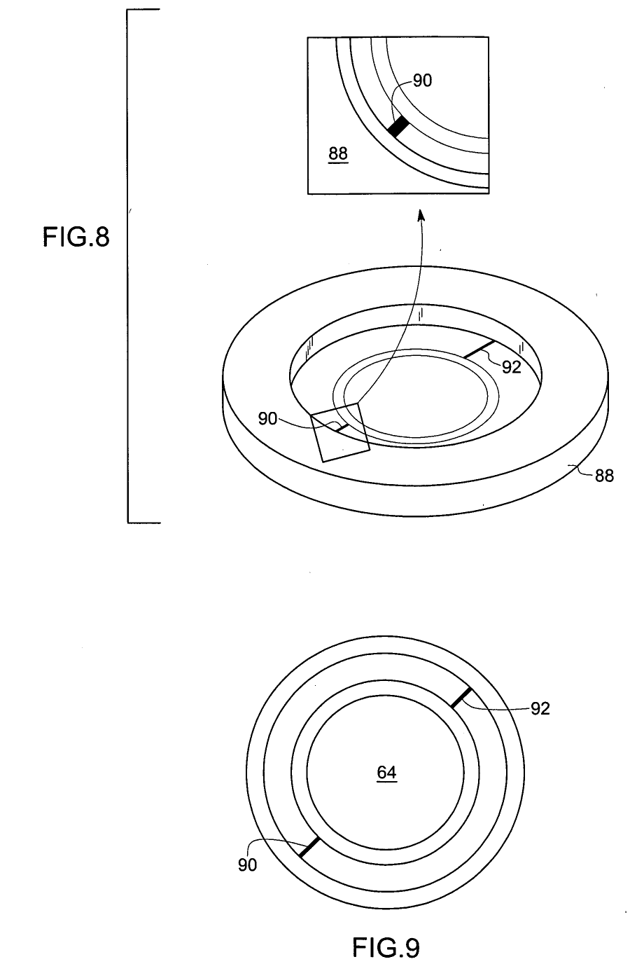

The top-view of the gage 88 is illustrated in FIG. 9, wherein the conductive path established by the work piece 64 with the gage is shown. It may be noted that once the conductive path is established between metal strips 90 and 92 because of placement of the work piece 64 on the gage 88, the timer circuit begins to operate. The timer therefore establishes the duration of operation of the work piece 64 on the gage. In one embodiment, the data on duration of use of the work piece 64 is transmitted to the central monitoring station. In a different embodiment, the conductive path, made by the metal strips 90 and 92, initiates a transmitter that sends information on the beginning and end of operation of the work piece 64 on the worktable. In such a case, the duration of use may be established at the central monitoring station.

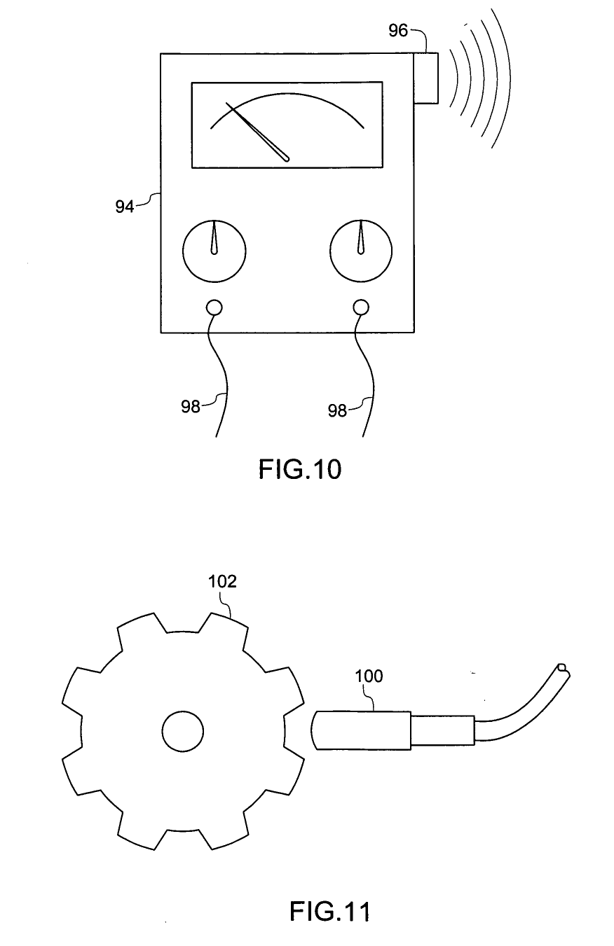

Referring generally to FIG. 10, an illustration of a multi-meter 94 coupled to a sensor and a transmitter 96 for use in monitoring the usage of the tool is illustrated. The leads 98 of the multi-meter 94 are in electrical coupling with the sensor and the tool, such that when a conductivity path is established by the multi-meter 94, which indicates the beginning of operation of the tool, the transmitter 96 transmits a signal indicative of the beginning of operation of the tool to the central monitoring station. The central monitoring station thus begins establishing the duration of use of the tool until the transmitter 96 ceases to transmit the signal.

In an alternate embodiment, the transmitter 96 transmits the signal to the local storage and processing device 32, illustrated in FIG. 2. In such a case, the local storage and processing device 32 begins establishing the duration of use of the tool until the transmitter 96 ceases to transmit the signal. In another alternate embodiment, the transmitter 96 transmits the duration of use of tool directly to both the local storage and processing device 32 and central monitoring station 22.

In a different embodiment, the usage of an electrically operated tool or gage may be monitored. For example, if the tool or gage is a multi-meter, such as multi-meter 94, the sensor 14 may be coupled to the switching mechanism of the multi-meter 94, such that whenever the multi-meter 94 is switched into an on state, the transmitter 96 will transmit a signal indicative of the operation of the multi-meter 94.

Referring generally to FIG. 11, a diagrammatic view of an acoustic sensor that may be utilized for gear movement detection has been illustrated. The acoustic sensor 100 produces acoustic signals that are reflected from the gear wheel 102. The acoustic sensor 100 is operable to receive and detect the echoes generated by the gear wheel 102. The echoes generated when the gear tooth is directly opposite to the acoustic sensor 100 will take a lesser duration of time compared to when the gear tooth is not directly opposite to the acoustic sensor 100. Therefore, spinning or rotation of the gear wheel 102 may be detected. Thus, if a shaft is coupled to the gear wheel 102, the motion of the shaft may be detected. In cases where the movement, such as a spin or rotation of the shaft or a gear wheel corresponds to the operation of the tool, such a scheme can be advantageously implemented.

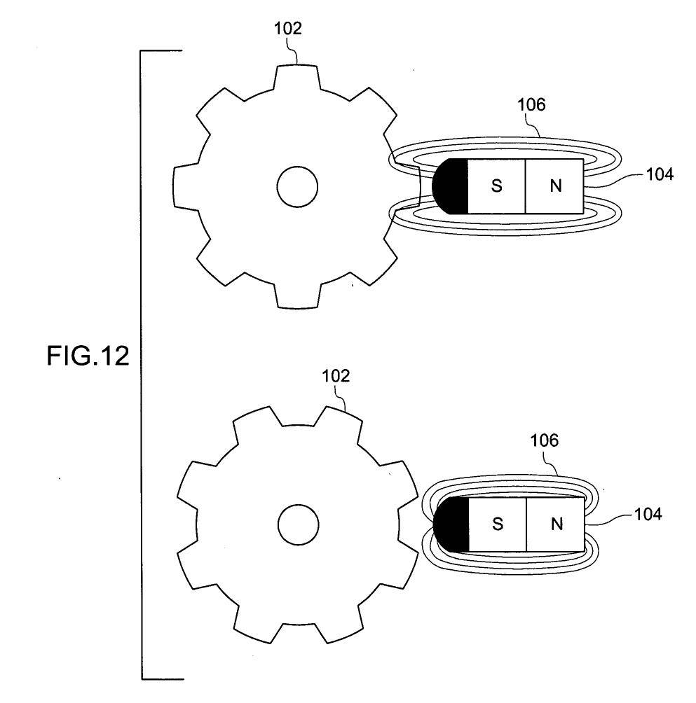

Another method for detecting movement of a gear wheel 102 is by utilizing a magnetic sensor. FIG. 12 illustrates a diagrammatic view of a magnetic sensor 104 for detection of gear movement. As illustrated, the magnetic flux 106 generated by the magnetic sensor 104, is more when the gear tooth is in direct proximity to the magnetic sensor 104, as compared to when the gear tooth is not in direct proximity to the magnetic sensor 104. The change in magnetic flux 106 thus indicates movement of the gear wheel. Therefore, the spinning or rotation of the gear wheel 102 may be monitored and utilized as described with respect to FIG. 11.

It may be noted that in the various embodiments illustrated in FIG. 4 through FIG. 12, a timer may be initiated to establish the duration of usage of the tool. The duration may be transmitted to the local storage and processing device 32 and/or the central monitoring station 22. When the duration data indicates that the tool has been utilized for a period, or a number of times, that it was designed to provide reliable readings, or it is nearing the duration of reliable operation, an alert may be provided as noted above. Further, in the various embodiments illustrated in FIG. 4 through FIG. 12, the detection may initiate a signal transmission to the local storage and processing device 32 and/or the central monitoring station 22, where the duration may be established. In such cases, the signal transmission begins when the operation of the tool begins and ceases when the operation of the tool ends.

As had been described above, proximity sensors and switches may be utilized for detecting tool usage. One example of proximity sensors and switches that may be used is a photoelectric proximity sensor, such as through beam type sensors, retro-reflective type sensors, diffuse type sensors, fiber optic type sensors, etc. Such types of sensors can be used in long ranges. Other examples of proximity sensors and switches are inductive proximity sensors, capacitive proximity sensors, magnetic proximity sensors, reed proximity sensors, and ultrasonic sensors. For detection of rotation and spin, hall-effect sensors and acoustic sensors may be utilized. Similarly, mechanical impact sensors and accelerometers may detect mechanical impact, which may be indicative of the beginning or end of operation of tools or calibrated devices. Mechanical tilt switches and mercury tilt switches may be used to detect tilting of the work piece on a worktable. Such tilt switches may be useful where the tool or the calibrated device tilts while in operation. A simple contact switch or a piezoelectric sensor may be used to initiate a timer circuitry when a tool or calibrated device or work piece is disposed on top of the same. Acceleration and inertia switches can be used for cases involving acceleration, spin, impact, recoil, directional and vibration sensing.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A tool usage monitoring system, comprising:
a sensing element operable to detect when a tool is in use and to produce a signal representative of tool usage;
a processor-based device communicatively coupled to the sensing element, wherein the processor-based device is programmed to maintain a running total of tool usage based on the signal representative of tool usage, and wherein the processor-based device also is operable to store a defined tool usage total corresponding to the tool; and
a user interface communicatively coupled to the processor-based device, wherein the processor-based device is programmed to send a signal to the user interface when the running total of tool usage one of equals or exceeds the defined tool usage total.

2. The system as recited in claim 1, comprising a wireless transmitter communicatively coupled to the sensing element, wherein the transmitter is operable to transmit the signal representative of tool usage.

3. The system as recited in claim 1, comprising a receiver communicatively coupleable to the processor-based device, wherein the receiver is operable to receive the signal representative of tool usage and to couple the signal to the processor-based device.

4. The system as recited in claim 1, wherein the signal representative of tool usage comprises a signal representative of the tool being in use.

5. The system as recited in claim 1, wherein the signal representative of tool usage comprises a signal representative of a sum of each time that the tool was in use.

6. The system as recited in claim 1, wherein the signal representative of tool usage comprises a signal representative of duration of use of the tool.

7. The system as recited in claim 1, wherein the sensing element is operable to detect when the tool is in use by detecting when a work piece is disposed proximate to the tool.

8. The system as recited in claim 7, wherein the sensing element comprises a light source and an optical receiver, wherein the work piece prevents light from the light source from being received by the optical receiver when the work piece is disposed proximate to the tool.

9. The system as recited in claim 8, wherein the sensing element produces a signal representative of tool usage when light from the light source is not received by the optical receiver.

10. The system as recited in claim 7, wherein the sensing element is operable to detect when the work piece rotates.

11. The system as recited in claim 1, wherein the tool is electrically operated and the sensing element is operable to detect when the tool is turned on and when the tool is turned off.

12. The system as recited in claim 1, wherein the processor-based device is located remotely, and wherein the processor-based device is operable to provide a notification to a user automatically when the running total of tool usage achieves the defined tool usage total.

13. The system as recited in claim 1, wherein the processor-based device comprises a database operable to store tool usage data.

14. A gage monitoring system, comprising:
a sensing element operable to detect when a work piece is disposed proximate to the gage and to provide a signal representative of the work piece being disposed proximate to the gage; and
a wireless transmitter communicatively coupled to the sensing element, wherein the wireless transmitter is operable to transmit a signal representative of gage usage based on the signal representative of the work piece being disposed proximate to the gage.

15. The system as recited in claim 14, comprising a processor-based device communicatively coupleable to the sensing element, wherein the processor-based device is operable to establish a running total of tool usage.

16. The system as recited in claim 15, comprising a display communicatively coupled to the processor-based device, wherein the processor-based device is operable to display a running total of tool usage.

17. The system as recited in claim 15, wherein the processor-based device is operable to compare the running total of tool usage to a defined amount of tool usage and to produce a signal when the running total of tool usage achieves the defined amount of tool usage.

18. The system as recited in claim 17, comprising a display communicatively coupled to the processor-based device, wherein the display is operable to display a visual indication indicative of the running total of tool usage achieving the defined amount of tool usage.

19. A method of maintaining a device, comprising:
sensing actual use of the device;
communicating data on actual use of the device to a processor-based device;
operating the processor-based device to automatically maintain a total of actual use of the device;
inputting a defined device usage corresponding to a maintenance activity into a processor-based device; and
operating the processor-based device to notify a user automatically when the total of actual usage of the device achieves the defined device usage.

20. The method as recited in claim 19, comprising performing the maintenance activity, wherein the maintenance activity comprises a calibration check.

21. The method as recited in claim 20, comprising inputting whether or not the device passed the calibration check into the processor-based device.

22. The method as recited in claim 20, comprising revising the defined device usage corresponding to the maintenance activity based on whether or not the device passed the calibration check.

23. The method as recited in claim 19, wherein sensing actual use of the device comprises coupling a sensor to the device.

24. The method as recited in claim 19, wherein communicating the data on actual use of the device to the processor-based device comprises communicating when the device is in actual use.

25. The method as recited in claim 19, wherein communicating the data on actual use of the device to the processor-based device comprises communicating duration of actual use of the device.

26. The method as recited in claim 25, wherein communicating the data on actual use of the device to the processor-based device comprises transmitting actual use of the device data wirelessly to a receiver coupled to the processor-based device.

27. The method as recited in claim 19, wherein communicating the data on actual use of the device to the processor-based device comprises communicating a sum of times the device was actually in use.

28. The method as recited in claim 19, wherein operating the processor-based device to notify a user automatically when the total of actual usage of the device achieves the defined device usage comprises displaying the notification on a monitor coupled to the processor-based device.

29. A computer program, comprising:
programming instructions stored in a tangible medium, wherein the programming instructions direct a processor to receive usage data of the calibrated device and direct the processor to produce a signal to indicate to a user to check calibration of the calibrated device when a running total of usage of the calibrated device achieves a predefined amount of usage.
